(19) United States
(12) Patent Application Publication
(10) Pub. No.: US 2016/0312646 A1
(43) Pub. Date: Oct. 27, 2016

(54) ELECTRICITY GENERATION AND WATER DESALINIZATION IN CONSTRUCTED SHAFTS UTILIZING GEOTHERMAL HEAT

(71) Applicant: Derric Juano, Stockton, CA (US)

(72) Inventor: Derric Juano, Stockton, CA (US)

(21) Appl. No.: 15/090,381

(22) Filed: Apr. 4, 2016

Related U.S. Application Data
(60) Provisional application No. 62/150,609, filed on Apr. 21, 2015.

(51) Int. Cl. F01D 15/10; C25B 9/04; C25B 1/04; H02K 7/18; C02F 1/16

(52) U.S. Cl. CPC F01D 15/10; H02K 7/1823; C02F 1/16; C25B 1/04; C25B 9/04; C02F 2103/08

(57) ABSTRACT

An apparatus for generating electricity and desalinating water is disclosed, which utilizes one or more subterranean shafts to convey seawater down to an operating depth of several miles at which electrical generators are driven from turbines to generate electricity conveyed to the surface. A desalinating stage then receives generator water output, and heats this water in response to ambient shaft temperature to distill the water. Desalinated water is coupled to a vertical shaft where it flashes to steam and travels up to steam turbine equipment and then to a condensation facility at the surface which condenses the desalinated steam back into pure liquid water for distribution. Power is also generated from the rising steam as well as converting potential water energy between elevation of condensation facility and the lower elevation of a water distribution facility receiving the desalinated water.

### CROSS-REFERENCE TO RELATED APPLICATIONS

This application claims priority to, and the benefit of, U.S. provisional patent application Ser. No. 62/150,609 filed on Apr. 21, 2015, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technological Field

This technical disclosure pertains generally to electrical generation, and more particularly to deep underground hydro electrical generation.

2. Background Discussion

Many of the prevailing methods of generating electricity create significant levels of pollution (e.g., coal, oil, or shale fired power plants). It will be noted that during the heyday of nuclear power plants, there were significant concerns about not only safety, but about the long half-life of the radioactive waste products. However, it is often forgotten that the chemical wastes generated by coal, oil and shale fired power plants remain toxic indefinitely. Thus, there has been a long-held desire for producing abundant electrical energy in a clean manner.

One method which held the promise of producing “clean” electricity were hydroelectric power plants, such as those associated with the system of dams constructed for harnessing the power of water retained behind these dams placed along rivers.

However, it has been found since the construction of these hydroelectric dam projects, that even these “clean” forms of power pose significant problems to the environment, including but not limited to the following: (1) flooding of large tracts of land in flat basin areas destroying local animals and habitats; (2) displacement of peoples, with some 40 to 80 million people physically displaced by dams worldwide; (3) submerging substantial plant life, subject to decay anaerobically which generates huge amounts of greenhouse gases like methane, with estimates that a hydroelectric power plant produces 3.5 times the amount of greenhouse gases as a thermal power plant burning fossil fuels; (4) destruction of migratory patterns of river animals, including salmon and trout; (5) a restriction of sediment flow in which these sediments are unavailable for keeping downstream lands fertile—requiring significant fertilization/mineralization inputs from farmers; (6) water flow restriction caused by the dams, resulting in salt water intrusion into the delta areas, water which cannot be used for irrigation; (7) increased risk of landslides; (8) dammed water reservoirs become breeding grounds for mosquitoes thus leading to the spread of disease; (9) downstream farmers cannot rely on yearly flooding of their fields when raising crops; (10) dammed water reservoirs serve as a heat sink, warming the water significantly above normal levels causing additional death/stress of downstream animal life; (11) peak power operations at a hydroelectric dam can cause river water levels to change 30-40 feet in a single day, thus killing animal in shoreline habitats; and additional problems arise with these hydroelectric dams as will be recognized by those in the power industry, and those concerned with environmental issues. Numerous dam removal projects have been performed, with others underway or planned, In the United States by 2013 there were already nearly 1,150 dams removed across the country since 1912, with nearly 850 of those being removed in the past 20 years (See www.americanrivers.org).

The recognition of these ecological problems with present hydroelectric dams is not limited to the United States. By way of example, the disastrous ecological impacts of the world's largest hydroelectric dam, the Three Gorges Dam in China, is being acknowledged by that government. Last year officials recognized how that dam has triggered landslides and altered entire ecosystems causing many serious environmental problems. For the above reasons, the building of new hydroelectric dams has substantially ceased in the United States, and has been at least significantly curtailed in many other countries.

Other energy collection strategies, including wind and solar power are being utilized; however, they have significant limitations in regard to the amount of power which can be generated, cost factors, and maintenance.

Towards overcoming the above shortcomings, attempts have been made to extract geothermal heat for generating electricity. Although, these processes initially held out the promise of clean energy, it was found that practical systems required injecting water into the Earth at the geothermal vent regions which permeates through the rock layers and thus released significant pollutants returned to the surface. These problems are in addition to the fact that the geothermal vents relied upon are few in number, and can be positionally unstable, for example an earthquake can readily cause a vent to close or move.

Adding to the problem of obtaining clean electric power, an increasing percentage of the world is suffering from a lack of drinkable water. Converting sea water to drinking water has been heretofore a very expensive means of creating drinking water, and thus afforded by only the wealthiest regions.

Accordingly, a need exists for truly clean forms of energy, as well as mechanisms for delivering large volumes of drinkable water at low cost. The disclosed technology overcomes the shortcomings of these previous forms of energy generation and water desalinization, while providing significant additional advantages.

### BRIEF SUMMARY

The present disclosure describes a system for generating usable electrical energy, while it can also provide for desalinization of waters from a source (e.g., ocean water), and generation of hydrogen. Very large diameter deep underground shafts are utilized in the system for accessing the geothermal energy of the Earth. Furthermore, the system can provide atmospheric moisture enhancement toward increasing precipitation.

This system relies on new advances in shaft boring technology which allows the creation of these shafts of a diameter on the order of 100 feet. Utilizing the presented technology, abundant water and electricity can be made available virtually anywhere in the world where salt water is readily obtainable.

Although it has been a long held belief that geothermal energy is only attainable near tectonic plate edges or where the Earth's crust is the thinnest, the present disclosure demonstrates that geothermal energy can be obtained virtually anywhere in the world using the present disclosure which relies on state of the art shaft boring technology.

In at least one embodiment, the system comprises an insulated intake shaft (e.g., approximately 100 feet in diameter), such as bored down to a depth of several miles (e.g., preferably 3-6 miles in depth), to an underground generating station. Sea water, input through a pipe contained in the intake shaft, drops through this pipe several miles in depth, delivering this hydroelectric power to a turbine generator. Water output from the generators is heated up by the Earth at this depth and converted to high steam pressure that is allowed to escape through a steam output pipe in the intake shaft or a separate output shaft. The high pressure steam travels up the output shaft to the surface where it is preferably utilized to drive a turbine, to generate additional electricity, after which the steam is cooled in a condenser to desalinated liquid water or converted into hydrogen by electrolysis. Liquid remnants of the desalinization process comprise a brine liquid that is pumped back up through a brine pipe back out to the ocean in an outlet preferably separated from the water intake.

In at least one embodiment, a portion of the generated energy can be utilized in an electrolysis process for breaking a portion of the water down into hydrogen and oxygen. The oxygen may be similarly conveyed, utilized within the generator station, used to oxygenate the brine water output, disposed of, or used in other ways and/or combinations thereof.

Further aspects of the presented technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The disclosed technology will be more fully understood by reference to the following drawings which are for illustrative purposes only:

FIG. 1 is a schematic diagram of generating electricity and desalinated water utilizing geothermal heat in a multiple shaft closed system according to an embodiment of the present disclosure.

FIG. 2 is an end cross-section of the subterranean shaft at the generation level with its turbine and generator according to an embodiment of the present disclosure.

FIG. 3 is a side cross-section of the subterranean shaft at the generation level with its turbine and generator according to an embodiment of the present disclosure.

FIG. 4 is an end cross-section of the shaft at the water distillation stage according to an embodiment of the present disclosure.

FIG. 5 is an end cross-section of the shaft at the source water inlet of a vertical shaft leading to the subterranean generation level according to an embodiment of the present disclosure.

FIG. 6 is a side cross-section of the shaft at the source water inlet of a vertical shaft leading to the subterranean generation level according to an embodiment of the present disclosure.

FIG. 7 is a schematic diagram of generating electricity and desalinated water utilizing geothermal heat in a single shaft closed system according to an embodiment of the present disclosure.

FIG. 8 is a schematic diagram of a turbine connected to a generator at the turbine stage according to an embodiment of the present disclosure.

FIG. 9 is a schematic diagram of desalination stages according to an embodiment of the present disclosure.

FIG. 10 is a schematic diagram of a high pressure steam chamber utilized according to an embodiment of the present disclosure.

FIG. 11 is a side cross section of the shaft at the generator stages according to an embodiment of the present disclosure.

FIG. 12 is a side cross section of the shaft at the desalination stages according to an embodiment of the present disclosure.

FIG. 13 is a side cross section of the shaft at the top of the steam chamber according to an embodiment of the present disclosure.

FIG. 14 is a side cross section of the shaft at the bottom of the steam chamber according to an embodiment of the present disclosure.

### DETAILED DESCRIPTION

1. Introduction.

In the present disclosure, electricity and potable water can be generated without any significant pollution output. The system is configured to convey water from a source (e.g., ocean water, sea water) through pipes in one or more deep shafts (e.g., on the order of miles below the surface, and preferably three or more miles below surface) down to an underground generating station. The velocity of the source water increases as it descends to the level of the generating station in which turbines are coupled to generators, or other form of hydroelectric converters, to convert the fast moving water to electrical power. In addition, the temperature of the water is increased as the ambient earth or rock temperature at the depth of the generating station is sufficient to drive desalinization. In at least one embodiment, the shaft is of sufficient depth that the earth's temperature surrounding the generating station exceeds the boiling point of water.

The system is a somewhat closed system, in that the water is received through pipes to and from the generation facility and not injected into the Earth which can permeate rock and release pollutants. It will be noted that there are many issues arising from an oil/gas collection technique referred to as “fracking”, in which high-pressure water (or water with sand or chemicals) is directed through deep wells at underlying rock to release gases inside. The present disclosure is semi-closed in that it does not involve these underground releases as in “fracking”. In addition, in the present disclosure at least one generation facility is located deep beneath the earth at a sufficient depth and/or location so that high ambient earth temperatures are available. The system is not completely closed as this creates additional problems (pressure regulations, buildup, etc.), while precluding the operation of desalinating. Typically, the system is configured for receiving seawater, although it can be alternatively configured for partially or fully utilizing lake water, treated sewage water, or similar, for power generation and distillation.

Although the primary power generation equipment is located deep in the system, embodiments are described in which additional hydroelectric generation occurs elsewhere in the system, for example in driving a turbine from the high pressure steam from the underground desalination output.

The desalinating and electrical generating equipment are configured for being removable and replaceable. In at least one embodiment, the equipment is divided into banks, thus allowing the system to operate even when one of the desalinating (desalinization) or generator banks is being serviced.

It will be appreciated that significant energy savings arise in the current desalinating process by releasing the output steam through a pipe(s) to the surface. This steam can be condensed to pure water for distribution (e.g., drinking, crops, industrial uses), or alternatively all or a portion of the steam may be released to the atmosphere, thus adding moisture to it, for example to increase likelihood of precipitation in that region. It will be noted that releasing the steam in this manner provides an ability to make it snow in certain areas of the world toward repairing the polar ice cap in the arctic, with the idea of directly reversing some effects of global warming.

In at least one embodiment, the system is configured to utilize at least a portion of the hydroelectric power generated for performing electrolysis to generate hydrogen from water (separating H₂O into its constituent hydrogen and oxygen, typically in a gaseous form (H₂ and O₂)). The hydrogen can be distributed, such as for use in hydrogen vehicles, power plants, and so forth.

2. Multiple Shaft Embodiment.

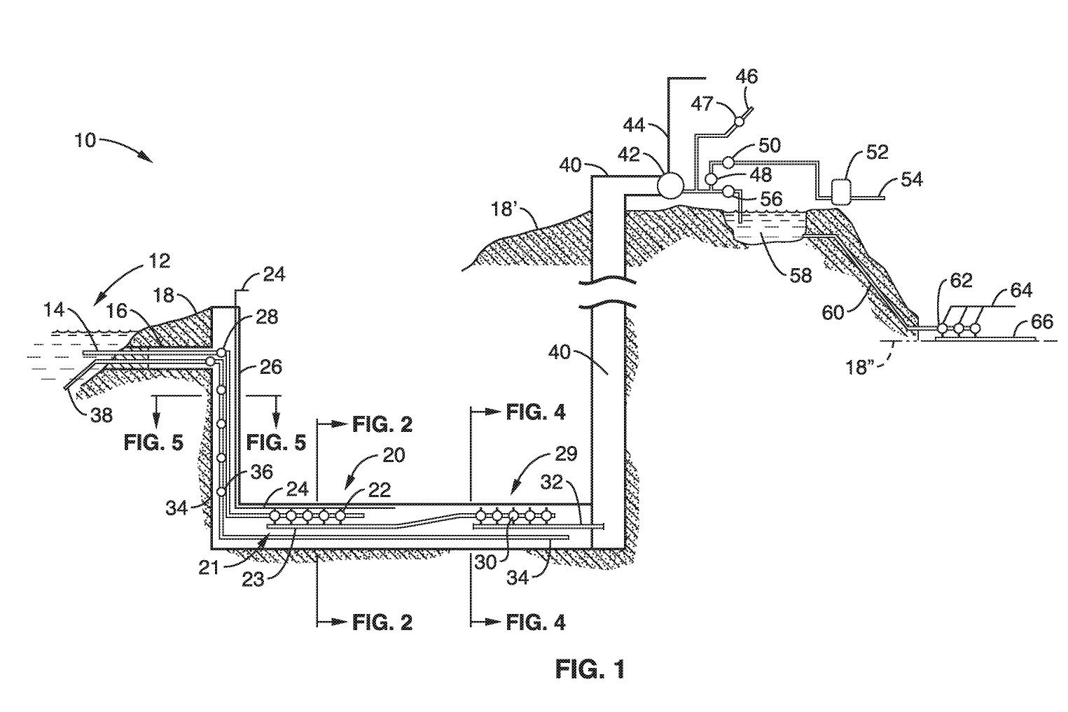

FIG. 1 illustrates an example embodiment 10 of the combination power generation and desalinating facility. A water source 12 is seen, such as an ocean which is received at a water intake 14 of the apparatus. Water intake 14 comprises at least one pipe whose flow is directed through a shaft system 16 to a significant depth below the earth surface 18 (subterranean) to an underground facility level 20 seen containing generating equipment 21, such as multiple turbine-generator devices 22.

It will be recognized that the received source water (e.g., sea water, or other preferably non-potable water) conveyed through pipes 14 is under tremendous pressure by the time it reaches the turbines of the generating station due to gravity flow of the source water through such a significant drop in elevation. It should be appreciated that turbines can be placed at intervals along the source water pipe to prevent excessive speed buildup of the source water as it travels down the shaft. The turbines are connected to generators which produce electricity which is conducted to the surface through conductors 24 for distribution. Water output 23 from the turbine travels to desalinating equipment 29.

The shaft walls through to the generation facility are thermally insulated 26, and one or more flow valves 28 are utilized for regulating the amount of seawater entering the system and thus controlling water pressure at the turbine intakes. The insulated walls in the down shaft and the generation facility, aid in preserving a workable environmental temperature for personnel and equipment. In at least one embodiment, the generators are housed in a horizontal portion of the shaft, or an interconnected horizontal shaft (e.g., sufficiently horizontal to simplify access and maintenance). However, it should be appreciated at least one embodiment is also described herein, in which the generator equipment and/or desalinating equipment are retained in vertical portions of a single shaft, and that a horizontal shaft portion is not a necessity of the present disclosure.

The steam pipe which conveys high pressure steam to the surface from the lower part of the shaft is preferably insulated to minimize heat loss and reduce condensation within the pipe and also to maintain a comfortable internal temperature within the shaft. If necessary to further minimize condensation, the pipe can be insulated by means of encasing or wrapping the pipe with an electric heating layer or other suitable means to minimize condensation in the steam received for power generation at the surface.

The generation facility level also houses a desalinating facility 29, with multiple desalinating units 30, which each receive the output water from the turbine (e.g., sea water) 23, and output desalinated water through pipe 32. The desalinating process also produces a brine byproduct carried through pipes 34, that is pumped by a series of pumps 36 back through the generator section and back up thru the intake shaft and into the water source (e.g., sea or ocean). In at least one embodiment, before being returned to the water source, the brine solution is received at one or more mineral recovery devices, which are configured for extracting valuable minerals from this high flow of concentrated sea water minerals. This processing can be performed at the generation facility, or at the surface, or a combination thereof. Various techniques exist for extracting minerals from a liquid, whereby there is no need for detailed discussion herein of those mechanisms. The desalinating sections of the shaft at the generator level are not insulated (e.g., with the exception of service accesses), so that the heat can be received into the water from ambient earth, which is at a high temperature exceeding the boiling point of the sea water.

In at least one implementation, source water exiting the turbines enters the desalinating equipment which is configured to absorb heat through portions of the tunnel, whereby the source water is boiled to perform steam distillation. The distilled water is discharged into a pipe that conveys it to the base of a vertical steam exhaust pipe or shaft where it flashes to steam under high pressure and through which it travels to the surface.

In at least one embodiment, the desalinization is performed in a serial and/or parallel sectioned process. These sections isolate the temperature mitigating effects of the incoming source water. For example, in a plurality of parallel sections, source water is received only until a section is sufficiently filled, then the section is allowed to heat until sufficient steam is generated, after which the section is then refilled. By including a plurality of these parallel sections, and a flow switching mechanism, a continuous flow through the generator(s) is dispersed through multiple parallel sections of desalination. In a serially sectioned process, temperature increases in stages along the series flow. One of ordinary skill in the art will recognize that many different serial and/or parallel mechanisms may be utilized with the present disclosure for generating the distilled water from the salt water input.

The brine wastewater is seen carried out through pipes 34 by a series of pumps 36, such as out to a brine output 38, which is located sufficiently distant from the source water intake so that saline concentrations picked up from the source are not significantly impacted (i.e., their saline levels are not significantly increased) by the brine output. In at least one embodiment, the brine output is distributed along a significant output length of the pipe (e.g., apertures spaced along the brine return) so that salt concentration is not significantly raised at any particular point along the brine return system, thus assuring that ocean plants and wildlife are not endangered or stressed.

In at least one embodiment, desalination is performed wholly or partially utilizing a reverse osmosis process. Utilizing reverse osmosis, the water can be desalinated either prior to or after it has been received at the generator turbines.

In the exemplified embodiment 10, the steam output from the desalination process is carried up through a separate shaft 40. It is preferred that this shaft be non-insulated, so that the heat at the bottom of the shaft rises and aids in carrying the steam to the surface of the earth. Thus, it is seen that the distilled water exits the desalination phase and enters the shaft which is not insulated from the Earth's heat allowing this heat to conduct through the shaft material (e.g., concrete tiles, or other suitable material) causing the water to turn into steam under tremendous pressure traveling at speeds possibly in excess of 200 mph towards the surface.

In at least one embodiment, the steam reaching the surface 18′ is directed through steam turbine generators (turbine coupled to a generator) 42, with the electricity produced being conveyed over power lines 44 to the power grid. It should be appreciated that the earth surface 18′ to where the steam is output, is preferably at an elevation above that of water distribution facilities so that additional electricity is generated from hydroelectric turbines at this distribution facility.

The spent steam is then conveyed to a valve 48 which can divert the spent steam to an electrolysis system 50, for separating constituent hydrogen and oxygen from the water (H₂O). In the example shown, the hydrogen is shown collected at a hydrogen storage tank 52, and distributed through a gas output system 54. It should be appreciated that in certain applications, it may be desired to similarly store the oxygen for distribution.

The spent steam is also shown being condensed back into liquid water at a condenser 56, and stored in a reservoir or cistern system 58, prior to distribution 60 to the municipal water supply. In at least one embodiment, if sufficient elevation exists, the distilled water can be released through pipe 60 down to lower elevations 18″ to drive additional hydroelectric turbines 62, with additional electricity coupled over power lines 64 to the power grid thus providing an additional benefit from the distilled water prior to its distribution 66 to the municipal water supply.

A vent valve 47 is also provided near the steam shaft allowing the system to vent steam directly 46 into the atmosphere if desired. Venting can be performed to maintain a proper pressure at the electrolysis and condenser, and/or to intentionally direct this water vapor into the atmosphere toward inducing precipitation (e.g., rain or snow) depending on the location of the system.

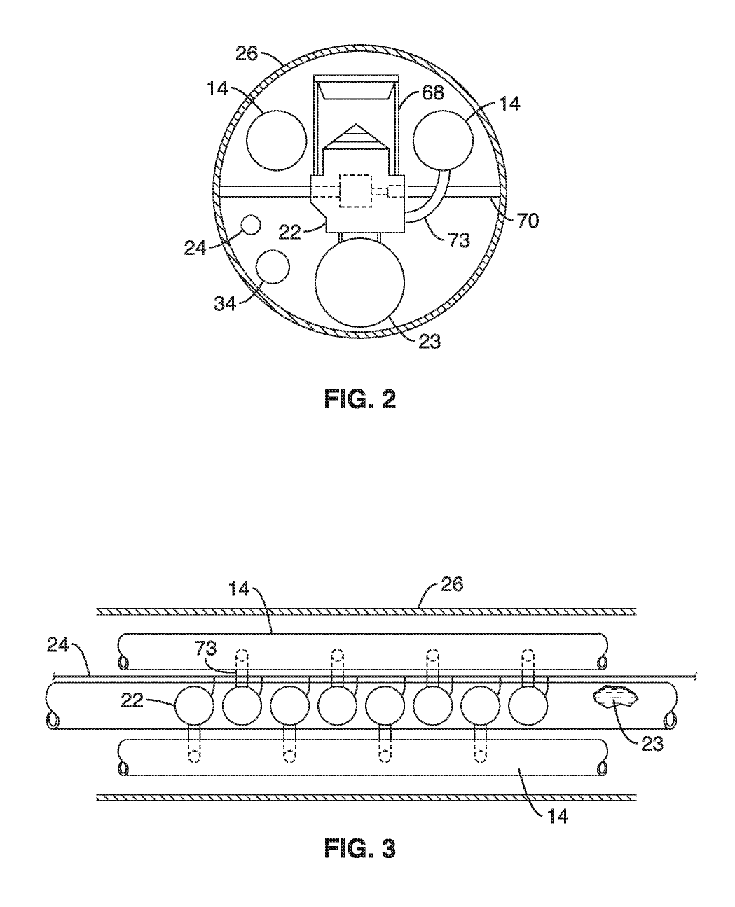

FIG. 2 through FIG. 6 illustrate additional structural aspects of at least one embodiment of the generating system.

In FIG. 2 is seen a cross section exemplifying the structure in the underground facility housing the combination of turbines and generators 22. A generator platform 70 is seen upon which the turbines and generators 22 are mounted, and upon which an insulated tunnel shaft 26 is seen configured. A crane 68 (horizontal or vertical depending on orientation of pipe section) is shown for allowing the movement of equipment through the shaft. Source water intake pipes 14 are seen with a turbine intake 73 seen for coupling the intake into the turbine. Output from the turbines is coupled to a turbine output (exhaust) 23. Also seen in the figure are a conduit through which the electrical output connections 24 pass through, and the brine return pipe 34. It should be appreciated that the configuration is shown by way of example and not limitation, as the arrangement of the constituent elements can be configured in a number of different ways without departing from the teachings of this disclosure.

In FIG. 3 the above elements are also seen in a side cut away showing source water intake pipes 14, multiple turbine intakes 73, turbine output (exhaust) 23, electrical output connections 24.

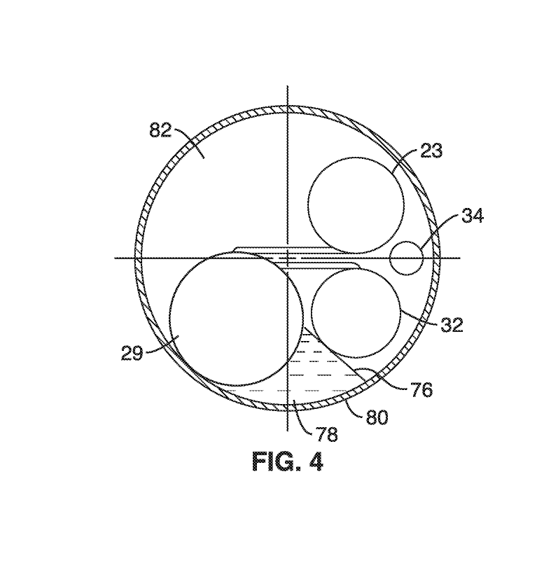

In FIG. 4 a cross section exemplifies water distillation, depicting turbine water output pipe 23 coupled to each multi-stage flash distillation (MSFD) unit 29, with distilled water output through pipe 32. This shaft portion is seen with a section 76 for retaining a working fluid 78, against a side of the shaft which is uninsulated 80. It will be appreciated that fluid may be alternately configured to flow around the full interior periphery of an uninsulated shaft (or any portion thereof) for coupling any desired amount of ambient earth temperatures into the water being distilled. The brine wastewater pipe 34 is also seen in this figure. The diagram also depicts the space 82 required for equipment installation and removal.

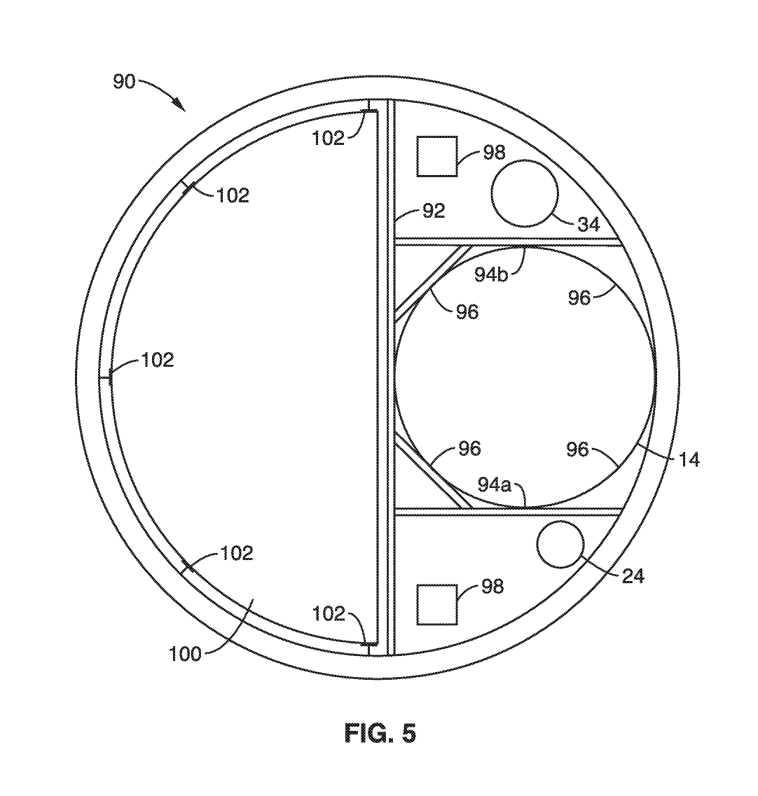

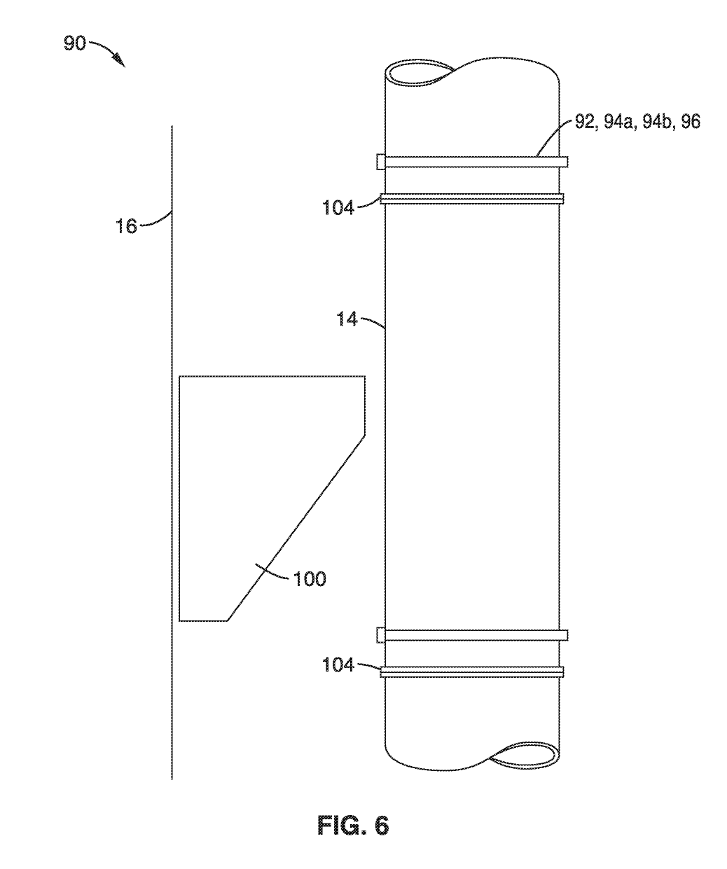

In FIG. 5 and FIG. 6 are seen an example embodiment 90 of structures in an intake shaft embodiment. Looking down into shaft 90 in FIG. 5, one can see a primary support 92 shown spanning the diameter of the pipe, along with secondary supports 94a, 94b, and multiple tertiary supports 96. In this embodiment, these supports are periodically spaced along the shaft, although full length structures can be utilized as desired. It will also be appreciated that different support structures may be utilized without departing from the teachings of the present disclosure. These supports are shown for supporting the source water pipe 14. One also readily sees the path of the electrical power line 24, and brine return 34 which were shown in FIG. 1. What is additionally shown in the figure are man lifts (elevators) 98, and an equipment elevator 100 and a plurality of tracks 102 over which the equipment elevator traverses. The man lifts allow personnel to access the entire system machinery. The equipment elevator is preferably configured of a sufficient capacity (weight and dimensions) for carrying all pieces of machinery in the system as needed preferably during both construction and maintenance.

A side view is seen in FIG. 6 of embodiment 90, showing more clearly the exemplified periodic nature of the support structure 92, 94a, 94b, 96 for the source water pipe 14, as well as the equipment elevator. It can be seen also that flanges 104 connect sequential sections of the source water pipe 14. The shaft 16 is preferably lined with insulated material (e.g., concrete tiles) thermally protecting the inside of the shaft from the Earth's heat at the lower depths. In addition, in at least one embodiment, a crane 68 in FIG. 2 or other form of lifting equipment, such as equipment elevator 100, is included for accessing the entire length of the shaft segment to carry replacement parts to and from the equipment elevator.

3. Single Shaft Embodiment.

A simplified embodiment is described below using a single vertical shaft which contains the majority of elements described in the previous sections. In this embodiment, seawater enters the intake pipe from the ocean (freshwater can also be used and the desalinization portion of the system can be omitted) and travels downward due to gravity. As the water travels downward, it passes through turbine generators that produce electricity transmitted through an electrical conduit back to the surface to into the power grid. The turbine generators can be placed at intervals, or more near the bottom of the shaft, or a combination thereof toward enhancing efficiency. After the seawater has gone through the turbine phase of the process it continues downward to the desalinization phase that extracts heat from the Earth through non-insulated portions of the shaft and then boils the seawater in a distillation process until it becomes sufficiently distilled. The brine that is produced is pumped, through a series of pumps, back to the surface where it can be processed for mineral extraction and then returned back to the ocean. The distilled water continues downward into the lowest part of the shaft which is preferably completely non-insulated allowing for full heat absorption from the Earth. The shaft is sealed off from the desalinization portion of the shaft making the bottom portion of the shaft essentially a boiler. The distilled water is fed into the bottom portion of the shaft by a pipe. Upon exiting the pipe, the distilled water will flash into steam nearly instantly. The steam will exit the bottom portion of the shaft via a steam pipe and travel to the surface where it can be harnessed for energy or released into the atmosphere. The following provide details of the above description.

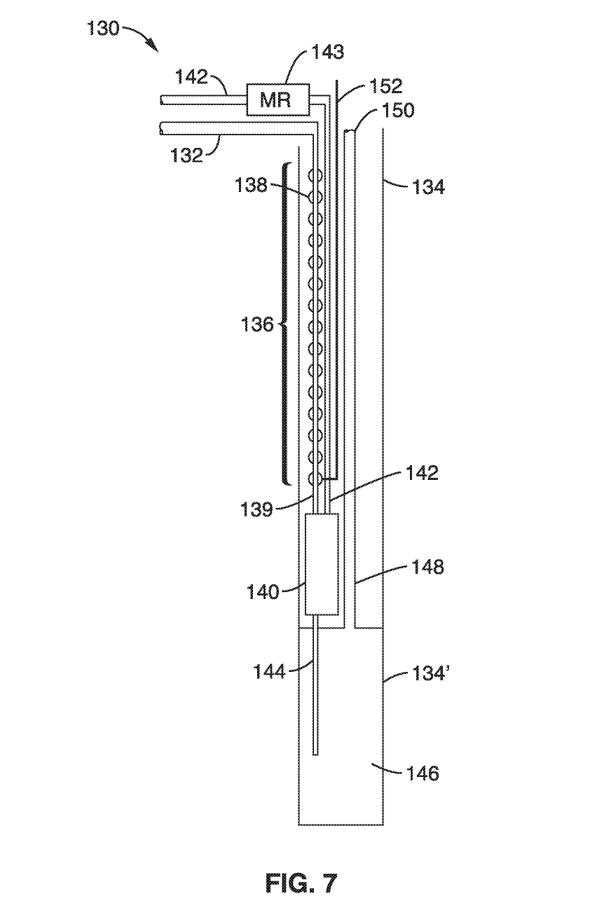

FIG. 7 illustrates an example embodiment 130 of generating electricity and desalinated water utilizing geothermal heat in a single shaft system that is semi-closed, in that fluids are not injected into the earth strata. Although this implementation lacks certain advantages of multiple shaft embodiments, it can be more readily implemented, as the entire process is performed along the depth of a single shaft.

A source water intake 132 is shown being received within a shaft having an upper region 134, which is insulated, and a lower portion 134′ which is uninsulated. Water, such as sea or ocean water, received through pipe 132 descends through a series 136 of turbine-generators 138 retained in shaft 134. Electrical output from the generators is coupled through electrical conductors 152. Water output 139 from the generator stages, is received in a desalination stage 140. A brine output pipe 142 is seen for carrying this high salt discharge (and containing other minerals) back out to the source water. An optional mineral recovery (MR) system 143 is seen in the brine return system for collecting valuable minerals for use and/or for collecting pollutants for proper storage/disposal. It will be appreciated that any desired techniques may be utilized for extracting these minerals from the brine, whereas the present disclosure need not discuss particulars of these methods. Fresh water output from desalination is carried through pipe 144 to a steam chamber 146 in which this fresh water is converted to steam for a return trip to the surface through a large diameter steam pipe 148, which exits 150 the surface, or more preferably is utilized for driving steam turbines and/or being condensed into liquid water as previously described.

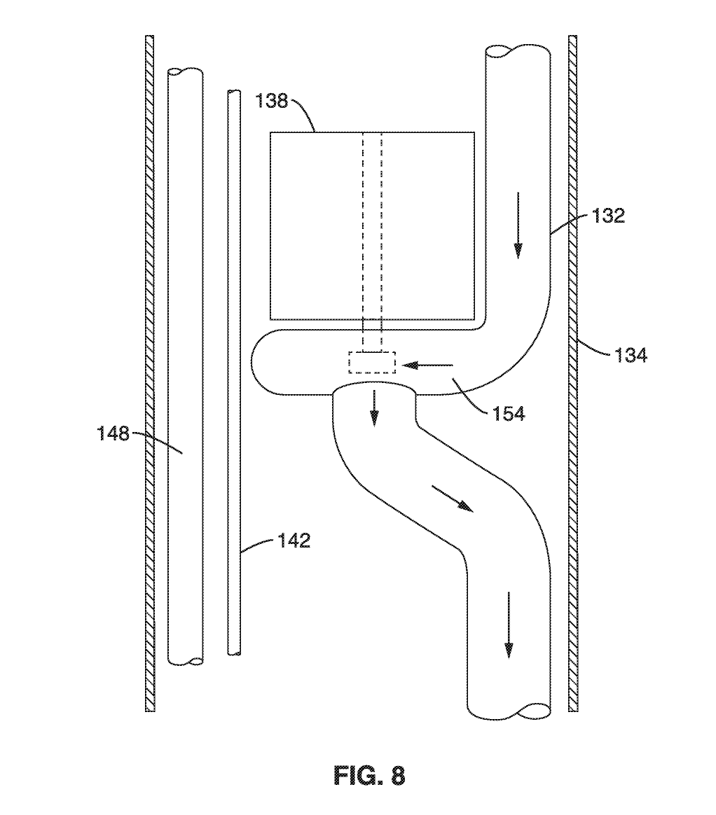

FIG. 8 illustrates an example embodiment 138 of a turbine connected to the source water intake pipe 132 in shaft 134 being received at a turbine 154 of generator 138. The brine pipe 142 and steam pipe 148 are seen being conveyed up past this turbine-generator stage. The wall in this section of the shaft is insulated for protecting any service personnel as well as the generating equipment itself.

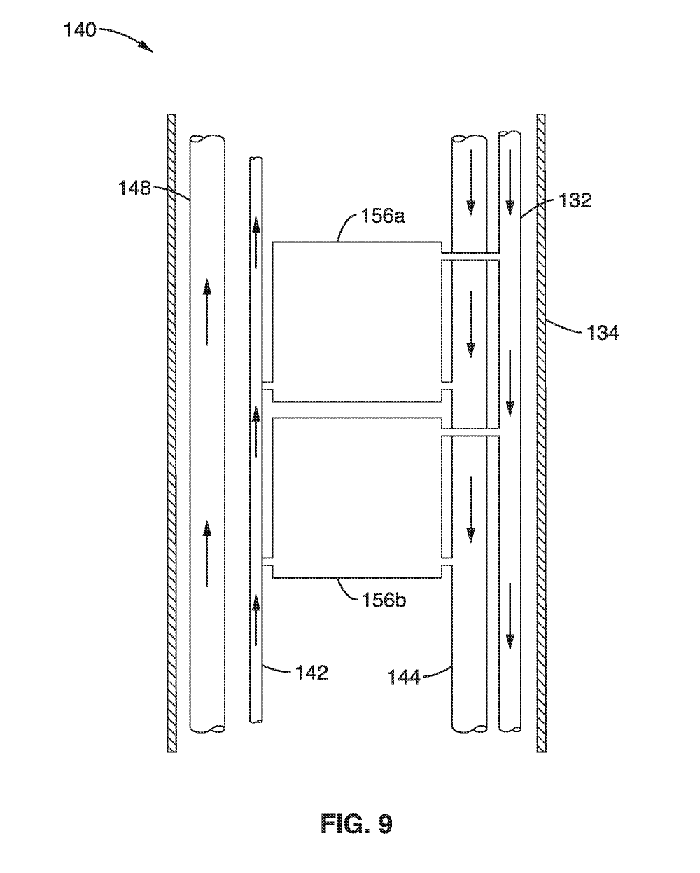

FIG. 9 illustrates an example embodiment 140 of desalination stages 156a, 156b, shown by way of example within shaft 134. Water output 132 from the turbine-generators 136, seen in FIG. 7, is received by a series of desalination units, within which this water is desalinated. Distilled water is output downward through pipe 144. Remnant water from desalination is a brine solution which is pumped back to the surface through brine return pipe 142. The distilled steam output pipe 148 is seen to pass up through these desalination stages on its way to the surface.

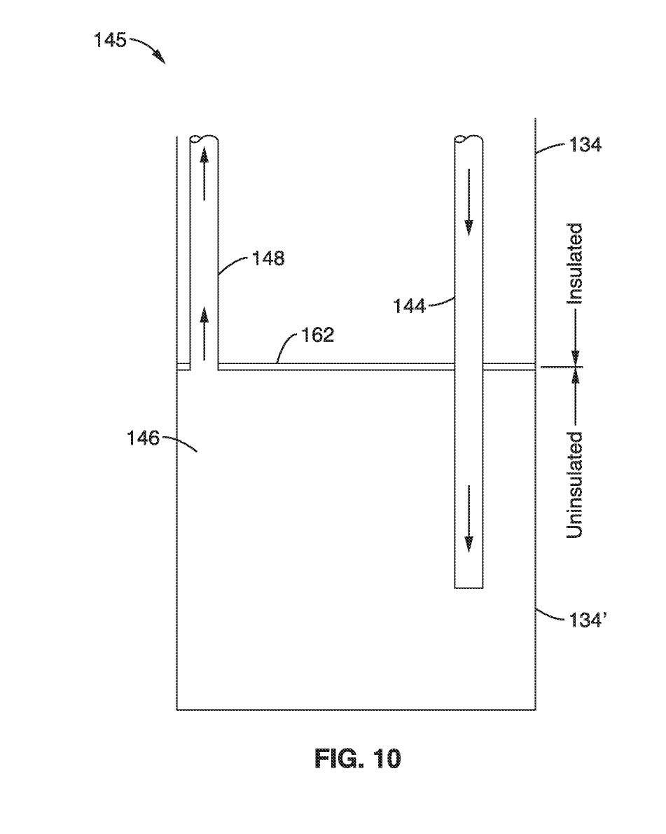

FIG. 10 illustrates an example embodiment 145 of a high pressure steam conversion exemplified herein as steam chamber 146 which is at the bottom of shaft 134, in an uninsulated section 134′ so that maximum coupling of heat takes place. Distilled water is carried through pipe 144 into this steam chamber 146, separated from the upper portions of the shaft by a top 162. In steam chamber 146 the distilled water is flash converted to distilled steam and output through steam pipe 148. These pipes are not shown to scale, as typically the steam pipe 148 is of a larger diameter than distilled water pipe 144. Obviously, the heated steam is capable of rising through steam pipe 148 without the need for pumping. It should be appreciated that in certain embodiments, some level of insulation may be utilized to limit heat intake, protect this portion of the shaft, or to otherwise provide desired characteristics.

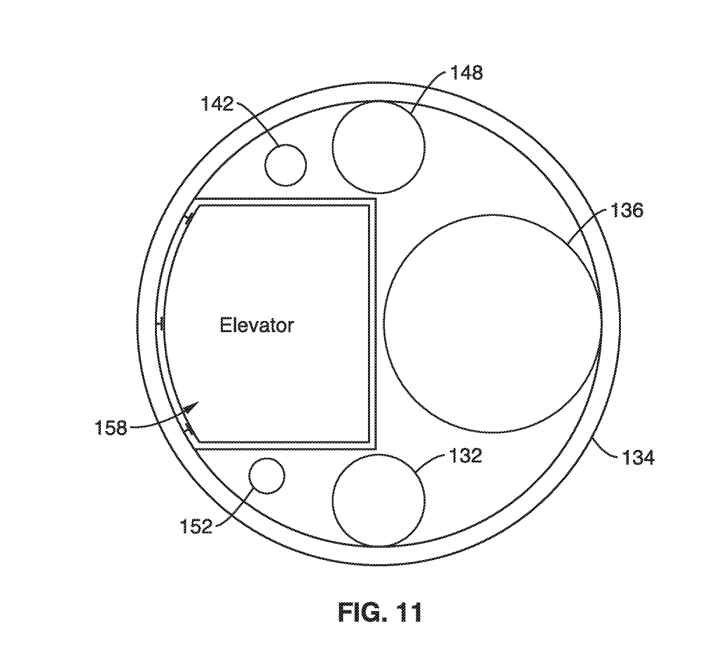

FIG. 11 illustrates an example embodiment of shaft 134 at the generator stages shown in cross section. In this figure one sees source water intake 132, turbine-generator stages 136, electrical output 152, brine output 142, and distilled steam output 148. In addition, this view indicates the use of an equipment elevator 158, shown preferably coupled to tracks allowing equipment and personnel to be moved vertically inside of shaft 134.

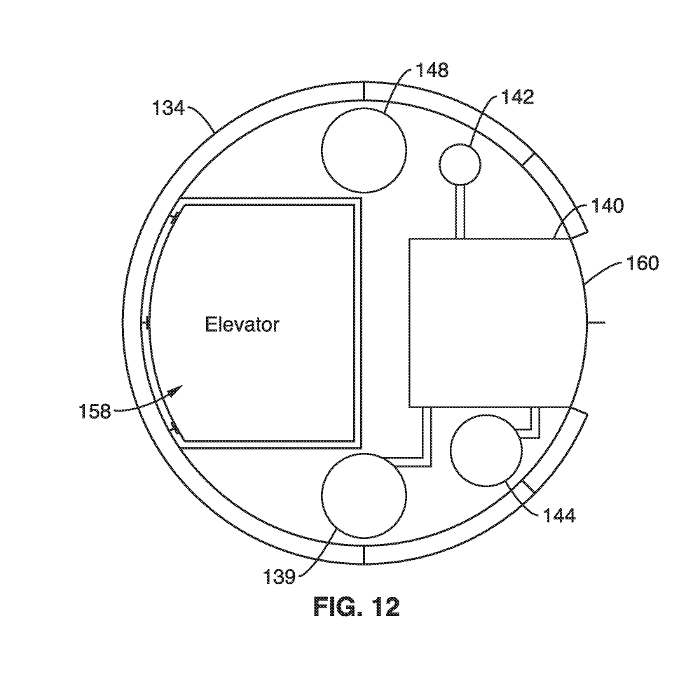

FIG. 12 illustrates an example embodiment of the shaft 134 at the desalination stages shown in cross section. In this figure one sees source water from turbine-generator output 139, distilled water output pipe 144, brine output 142, and distilled steam output 148 coming up from the steam chamber. In addition, this view also indicates the use of equipment elevator 158. It will be noted that a portion 160 of shaft 134 is shown uninsulated to couple heat into the desalination units 140.

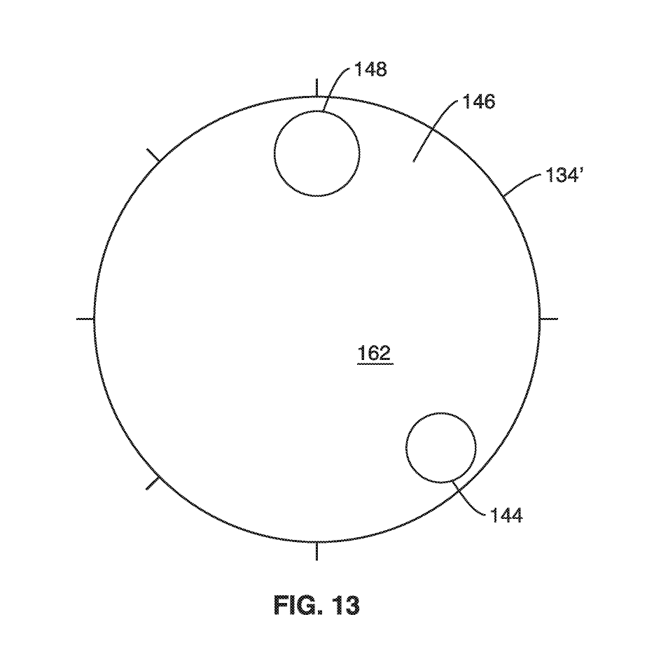

FIG. 13 illustrates an example embodiment of the shaft 134′ at the top of the steam chamber. A steel cover 162 closes off the top of the steam chamber with the exception of receiving distilled water through pipe 144, and outputting distilled steam through pipe 148 toward the surface.

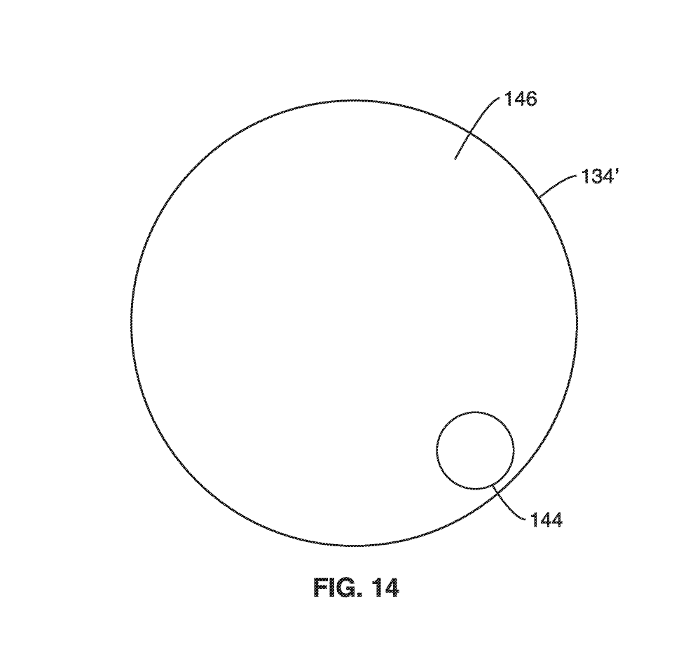

FIG. 14 illustrates an example embodiment of the shaft 134′ cross section in an intermediate position in the steam chamber. Distilled water is received through pipe 144 into the steam chamber 146, which is retained in an uninsulated portion 134′ of shaft 134.

It should be noted that in the above descriptions, equipment does not have to be placed within the confines of the nominal shaft structure. Any portion of the shaft can be modified or enlarged to better suit the layout of piping and equipment if the shaft is too narrow at a specific location.

The turbine generators can be positioned in series or in parallel with each other or a combination of both, the choice will depend on the design and capacity of the turbine itself.

At an operating speed of 37 mph, for the fastest elevator in the world, it would take only 7 minutes for the elevator to descend or ascend 4 miles. Although lower speed elevators can be utilized, short transit times will facilitate repairs and maintenance, while speeding crew transfers back and forth from the surface.

The described electrical generation and water desalination, in either single or multishaft embodiments, can also be used to filter harmful pollutants from the brine created during the process. The brine that is produced through the distillation process may contain pollutants, such as: arsenic, asbestos, atrazine (herbicides/pesticides), benzene, fluoride, lead, mercury, nitrate, trichloroethylene (TeE), trihalomethanes, radium, radon, biological contaminants (bacteria, viruses, and water-borne cysts like cryptosporidium), that can be extracted and recycled or disposed of before returning the brine back to the ocean or body of water from which it came. This filtration can dramatically reverse the effects of decades of pollution and begin the healing of our oceans for which there has been no feasible method until now. Mercury is a leading pollutant in our oceans caused by the burning of coal and other fossil fuels. Many fish and other sea life absorb this toxin and make it unsafe for human consumption at certain levels. The present disclosure mitigates this pollution directly in at least two ways. First, the present disclosure produces electricity cheaper than the burning of fossil fuels, thus eliminating the need to burn fossil fuels in this manner with its high levels of contamination. Secondly, by actually filtering the water that's been polluted as stated above, energy is produced while actually removing toxins.

In one embodiment of the described system, the water output of the system can be output in a manner to build a mountain of ice, such as for creating at least a portion of a space elevator. With the disclosed electricity generating system placed in an arctic region, snow and ice can be produced at a prodigious rate, thereby allowing formation of a mountain of ice. As the mountain of ice grows, new sections of pipe can be placed vertically on top of the previous section of pipe. As water is one of the most abundant resources on the planet and is readily available, this increases the practicality of a space elevator system.

From the description herein, it will be appreciated that the present disclosure encompasses multiple embodiments which include, but are not limited to, the following:

1. An apparatus for generating electricity and desalinating water, comprising: at least one subterranean shaft excavated down from a surface of earth reaching a sufficient operating depth at which ambient shaft temperature at that depth approaches or exceeds a boiling point of water; an electrical generation stage having turbines coupled to generators retained within said at least one subterranean shaft at said operating depth, in which source water is received through pipes in said at least one subterranean shaft and its kinetic energy is increased in falling through to said operating depth; electrical transmission cables passing through said at least one shaft and configured for connecting between said generators and power transmission facilities on the surface of the earth; a desalinating stage downstream of said generators, such that output water from said generators is heated in response to ambient shaft temperature at said operating depth to convert said output water from said generator into desalinated water; a brine return system coupled to said desalinating stage, said brine return system configured for pumping high saline remnant water from said desalinating stage out of said at least one subterranean shaft; and at least one steam output conduit configured for conveying steam traveling at high speed from said operating depth to a condensation facility for condensing of said desalinated steam back into liquid water.

2. The apparatus of any preceding embodiment, wherein said source water comprises saline water from a sea or an ocean.

3. The apparatus of any preceding embodiment, wherein said source water includes treated sewage water.

4. The apparatus of any preceding embodiment, wherein said electrical generation stage and said desalinating stage are in a portion of said shaft which is thermally insulated from its surrounding earth.

5. The apparatus of any preceding embodiment, wherein a shaft portion containing said desalinating stage is disposed at a depth sufficient to distill seawater using earth's heat.

6. The apparatus of any preceding embodiment, wherein said desalinating stage is retained in a portion of a shaft configured with sections of uninsulated walls so that ambient heat from the earth is directed to heating water which has passed through said electrical generation stage.

7. The apparatus of any preceding embodiment, wherein said condensation surface facility is configured with a vent to control release of said desalinated steam for adding moisture to surrounding atmosphere, toward increasing likelihood of precipitation in that region.

8. The apparatus of any preceding embodiment, wherein said source water is received downward through pipes from a first vertical subterranean shaft, while steam output from said desalinization stage is output upward through a second vertical shaft.

9. The apparatus of any preceding embodiment, wherein said second vertical subterranean shaft reaches the earth surface at a higher elevation than from which said first vertical shaft descends.

10. The apparatus of any preceding embodiment, further comprising an additional electrical generation stage, with turbines coupled to generators, configured for receiving the liquid water from said condensation surface facility; and wherein said additional electrical generation stage is at a sufficiently lower elevation than said condensation surface facility to generate electrical power.

11. The apparatus of any preceding embodiment, wherein said at least one subterranean shaft has a sufficient diameter to accommodate equipment and plumbing.

12. The apparatus of any preceding embodiment, wherein said at least one subterranean shaft carrying said source water and said shaft surrounding said electrical generation stage are configured to include thermal insulation for insulating these shaft portions from the heat of earth surrounding said subterranean shaft.

13. The apparatus of any preceding embodiment, further comprising horizontal and/or vertical elevators, or cranes, for conveying people and/or equipment to, or from, portions of said at least one subterranean shaft.

14. The apparatus of any preceding embodiment, further comprising a steam turbine-generator combination configured for generating electricity from said high pressure steam traveling up from said operating depth.

15. The apparatus of any preceding embodiment, further comprising a electrolysis stage for separating the distilled steam or condensed water from said desalinating stage into hydrogen and oxygen.

16. The apparatus of any preceding embodiment, further comprising facilities for storage and distribution of said hydrogen, or said oxygen, or a combination of both said hydrogen and said oxygen.

17. The apparatus of any preceding embodiment, further comprising one or more mineral recovery devices coupled to said brine return system and configured for extracting minerals from flow of brine as concentrated source water minerals.

18. An apparatus for generating electricity and desalinating water, comprising: a single subterranean shaft extending down from a surface of earth reaching a sufficient operating depth at which ambient temperature surrounding said first subterranean shaft at that depth approaches or exceeds water boiling point; an electrical generation stage having turbines coupled to generators retained within said single subterranean shaft at said operating depth, in which saline source water is received through pipes in said at least one subterranean shaft and its kinetic energy is increased in falling through to said operating depth; electrical transmission cables passing through said single subterranean shaft and configured for connecting between said generators and power transmission facilities on earth's surface; a desalinating stage coupled to said generators such that output water from the generators is heated in response to ambient shaft temperature at said operating depth to convert the water into desalinated water; a steam boiler at or near the bottom of said single subterranean shaft, below said desalinating stage, which is configured for heating the distilled water causing it to flash to steam which is conveyed from said operating depth through a steam pipe to a condensation facility at or near earth's surface for condensing this back into liquid water; and a brine return system configured for pumping high salt content brine, which is remnant water from said desalinating stage, out of said single subterranean shaft.

19. An apparatus for generating electricity and desalinating water, comprising: a first subterranean shaft extending down from a surface of earth reaching a sufficient operating depth at which ambient temperature surrounding said first subterranean shaft at that depth approaches or exceeds water boiling point; an electrical generation stage having turbines coupled to generators retained within said at least one subterranean shaft at said operating depth, in which saline source water is received through pipes in said at least one subterranean shaft and its kinetic energy is increased in falling through to said operating depth; electrical transmission cables passing through said at least one subterranean shaft and configured for connecting between said generators and power transmission facilities on earth's surface; a desalinating stage coupled to said generators such that output water from the generators is heated in response to ambient shaft temperature at said operating depth to convert the water into desalinated water; a second subterranean shaft extending upward from said desalinating stage to earth's surface and configured for heating the distilled water causing it to flash to steam which is conveyed from said operating depth to a condensation facility for condensing this back into liquid water; and a brine return system configured for pumping high salt content brine, which is remnant water from said desalinating stage, out of said at least one shaft.

20. The apparatus of any preceding embodiment, wherein said condensation surface facility is configured with a vent to control release of said desalinated steam for adding moisture to surrounding atmosphere, toward increasing likelihood of precipitation in that region.

21. The apparatus of any preceding embodiment, wherein said second subterranean shaft reaches an earth surface at a higher elevation than said first subterranean shaft.

22. The apparatus of any preceding embodiment, further comprising a steam turbine-generator combination configured for generating electricity from said high pressure steam traveling up from said operating depth through said second subterranean shaft.

23. The apparatus of any preceding embodiment, further comprising a electrolysis stage for separating a portion of the distilled steam or condensed water into hydrogen and oxygen.

24. The apparatus of any preceding embodiment, further comprising one or more mineral recovery devices coupled to said brine return system and configured for extracting minerals from this flow of concentrated source water minerals.

25. A method of generating electricity and desalinating water, comprising: excavating at least one subterranean shaft down from a surface of earth to reach a sufficient operating depth at which ambient shaft temperature at that depth approach or exceed the boiling point of water; coupling turbines to electrical generators in an electrical generation stage retained at said operating depth within said at least one subterranean shaft through which kinetic energy of source water is increased as it traverses to said operating depth; conveying electrical energy from said electrical generation stage to surface power facilities; desalinating source water which has passed through said electrical generation stage by heating said source water in response to ambient shaft temperature at said operating depth to convert the source water into distilled water output and brine; and conveying distilled water output from said desalinating to a vertical shaft through which heat from the shaft causes the distilled water to boil and flash to steam traveling up from said operating depth to be condensed at a surface facility back into desalinated liquid water.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for generating electricity and desalinating water, comprising:
at least one subterranean shaft excavated down from a surface of earth reaching a sufficient operating depth at which ambient shaft temperature at that depth approaches or exceeds a boiling point of water;
an electrical generation stage having turbines coupled to generators retained within said at least one subterranean shaft at said operating depth, in which source water is received through pipes in said at least one subterranean shaft and its kinetic energy is increased in falling through to said operating depth;
electrical transmission cables passing through said at least one shaft and configured for connecting between said generators and power transmission facilities on the surface of the earth;
a desalinating stage downstream of said generators, such that output water from said generators is heated in response to ambient shaft temperature at said operating depth to convert said output water from said generator into desalinated water;
a brine return system coupled to said desalinating stage, said brine return system configured for pumping high saline remnant water from said desalinating stage out of said at least one subterranean shaft; and
at least one steam output conduit configured for conveying steam traveling at high speed from said operating depth to a condensation facility for condensing of said desalinated steam back into liquid water.

2. The apparatus as recited in claim 1, wherein said source water comprises saline water from a sea or an ocean.

3. The apparatus as recited in claim 1, wherein said source water includes treated sewage water.

4. The apparatus as recited in claim 1, wherein said electrical generation stage and said desalinating stage are in a portion of said shaft which is thermally insulated from its surrounding earth.

5. The apparatus as recited in claim 1, wherein a shaft portion containing said desalinating stage is disposed at a depth sufficient to distill seawater using earth's heat.

6. The apparatus as recited in claim 1, wherein said desalinating stage is retained in a portion of a shaft configured with sections of uninsulated walls so that ambient heat from the earth is directed to heating water which has passed through said electrical generation stage.

7. The apparatus as recited in claim 1, wherein said condensation surface facility is configured with a vent to control release of said desalinated steam for adding moisture to surrounding atmosphere, toward increasing likelihood of precipitation in that region.

8. The apparatus as recited in claim 1, wherein said source water is received downward through pipes from a first vertical subterranean shaft, while steam output from said desalinization stage is output upward through a second vertical shaft.

9. The apparatus as recited in claim 8, wherein said second vertical subterranean shaft reaches the earth surface at a higher elevation than from which said first vertical shaft descends.

10. The apparatus as recited in claim 9:
further comprising an additional electrical generation stage, with turbines coupled to generators, configured for receiving the liquid water from said condensation surface facility; and
wherein said additional electrical generation stage is at a sufficiently lower elevation than said condensation surface facility to generate electrical power.

11. The apparatus as recited in claim 1, wherein said at least one subterranean shaft has a sufficient diameter to accommodate equipment and plumbing.

12. The apparatus as recited in claim 1, wherein said at least one subterranean shaft carrying said source water and said shaft surrounding said electrical generation stage are configured to include thermal insulation for insulating these shaft portions from the heat of earth surrounding said subterranean shaft.

13. The apparatus as recited in claim 1, further comprising horizontal and/or vertical elevators, or cranes, for conveying people and/or equipment to, or from, portions of said at least one subterranean shaft.

14. The apparatus as recited in claim 1, further comprising a steam turbine-generator combination configured for generating electricity from said high pressure steam traveling up from said operating depth.

15. The apparatus as recited in claim 1, further comprising a electrolysis stage for separating the distilled steam or condensed water from said desalinating stage into hydrogen and oxygen.

16. The apparatus as recited in claim 15, further comprising facilities for storage and distribution of said hydrogen, or said oxygen, or a combination of both said hydrogen and said oxygen.

17. The apparatus as recited in claim 1, further comprising one or more mineral recovery devices coupled to said brine return system and configured for extracting minerals from flow of brine as concentrated source water minerals.

18. An apparatus for generating electricity and desalinating water, comprising:
a single subterranean shaft extending down from a surface of earth reaching a sufficient operating depth at which ambient temperature surrounding said first subterranean shaft at that depth approaches or exceeds water boiling point;
an electrical generation stage having turbines coupled to generators retained within said single subterranean shaft at said operating depth, in which saline source water is received through pipes in said at least one subterranean shaft and its kinetic energy is increased in falling through to said operating depth;
electrical transmission cables passing through said single subterranean shaft and configured for connecting between said generators and power transmission facilities on earth's surface;
a desalinating stage coupled to said generators such that output water from the generators is heated in response to ambient shaft temperature at said operating depth to convert the water into desalinated water;
a steam boiler at or near the bottom of said single subterranean shaft, below said desalinating stage, which is configured for heating the distilled water causing it to flash to steam which is conveyed from said operating depth through a steam pipe to a condensation facility at or near earth's surface for condensing this back into liquid water; and
a brine return system configured for pumping high salt content brine, which is remnant water from said desalinating stage, out of said single subterranean shaft.

19. An apparatus for generating electricity and desalinating water, comprising:
a first subterranean shaft extending down from a surface of earth reaching a sufficient operating depth at which ambient temperature surrounding said first subterranean shaft at that depth approaches or exceeds water boiling point;
an electrical generation stage having turbines coupled to generators retained within said at least one subterranean shaft at said operating depth, in which saline source water is received through pipes in said at least one subterranean shaft and its kinetic energy is increased in falling through to said operating depth;
electrical transmission cables passing through said at least one subterranean shaft and configured for connecting between said generators and power transmission facilities on earth's surface;
a desalinating stage coupled to said generators such that output water from the generators is heated in response to ambient shaft temperature at said operating depth to convert the water into desalinated water;
a second subterranean shaft extending upward from said desalinating stage to earth's surface and configured for heating the distilled water causing it to flash to steam which is conveyed from said operating depth to a condensation facility for condensing this back into liquid water; and
a brine return system configured for pumping high salt content brine, which is remnant water from said desalinating stage, out of said at least one shaft.

20. The apparatus as recited in claim 19, wherein said condensation surface facility is configured with a vent to control release of said desalinated steam for adding moisture to surrounding atmosphere, toward increasing likelihood of precipitation in that region.

21. The apparatus as recited in claim 19, wherein said second subterranean shaft reaches an earth surface at a higher elevation than said first subterranean shaft.

22. The apparatus as recited in claim 19, further comprising a steam turbine-generator combination configured for generating electricity from said high pressure steam traveling up from said operating depth through said second subterranean shaft.

23. The apparatus as recited in claim 19, further comprising a electrolysis stage for separating a portion of the distilled steam or condensed water into hydrogen and oxygen.

24. The apparatus as recited in claim 19, further comprising one or more mineral recovery devices coupled to said brine return system and configured for extracting minerals from this flow of concentrated source water minerals.

25. A method of generating electricity and desalinating water, comprising:
excavating at least one subterranean shaft down from a surface of earth to reach a sufficient operating depth at which ambient shaft temperature at that depth approach or exceed the boiling point of water;
coupling turbines to electrical generators in an electrical generation stage retained at said operating depth within said at least one subterranean shaft through which kinetic energy of source water is increased as it traverses to said operating depth;
conveying electrical energy from said electrical generation stage to surface power facilities;
desalinating source water which has passed through said electrical generation stage by heating said source water in response to ambient shaft temperature at said operating depth to convert the source water into distilled water output and brine; and
conveying distilled water output from said desalinating to a vertical shaft through which heat from the shaft causes the distilled water to boil and flash to steam traveling up from said operating depth to be condensed at a surface facility back into desalinated liquid water.
